(19) United States
(12) Patent Application Publication
(10) Pub. No.: US 2009/0021639 A1
(43) Pub. Date: Jan. 22, 2009

(54) Audio and Video Communication

(76) Inventors: David William Geen, Glen Allen, VA (US); Robert Lockwood, Glen Allen, VA (US); Jingyi Hu, Glen Allen, VA (US)

Correspondence Address: JACOBSON HOLMAN PLLC, 400 SEVENTH STREET N.W., SUITE 600, WASHINGTON, DC, 20004, US

(21) Appl. No.: 12/224,216

(22) PCT Filed: Feb. 21, 2007
(86) PCT No.: PCT/IE2007/000025

§ 371 Date: Aug. 21, 2008

Related U.S. Application Data
(60) Provisional application No. 60/774,546, filed on Feb. 21, 2006.

(51) Int. Cl. H04N 5/04; G06F 15/16

(52) U.S. Cl. 348/500; 709/248; 348/E05.009

(57) ABSTRACT

In order to correct the skew experienced by the end user, a ‘reverse skew’ is applied by a video IVR, resulting in synchronized data at the edge. This is achieved by ‘sliding’ the time-bases of audio relative to video prior to delivery. Therefore, the data as received by the end user is synchronized. Media interfaces towards the video IVR are full duplex; the server corrects the skew in the respective halves of the duplex, particularly dependent on the type of service being deployed on the video IVR. For messaging applications, correcting the skew of the received data is important prior to the actual storage of the data. By applying the same technique as used for play-out, the skew can be corrected. The video IVR slides the time-base of audio relative to video before saving the multimedia data to the storage device. As a result, data saved is synchronized.

### INTRODUCTION

1. Field of the Invention

The invention relates to multimedia communication involving audio and video, such as in IP-based video IVR systems. In one example, the invention pertains to services deployed in communications networks in which exchange of multimedia data is sourced from or received by a video interactive response server (hereafter referred to as ‘video IVR’). Examples of such networks include broadband/cable networks, third generation mobile networks, and example services include video messaging and video portal services.

2. Prior Art Discussion

Successful user experience for communication such as video interactive services demands accurate lip synchronization. In many present systems, video end user devices (for example, 3G phones, softphones, broadband phones, and IM clients) exhibit lip synchronization problems due to skew which may be inserted within the device itself as well as intermediary equipments (such as gateways) between the end user device and the video IVR system.

Protocols used in IP based video IVRs do not provide a reliable means of providing for skew correction. Media (voice and video) is sourced/terminated on a video IVR via RTP/RTCP [1] protocols. While RTP as a protocol includes time-stamping information, timestamps on the voice and video streams are independent (i.e. not correlated to a unified wall clock).

RTCP as a protocol provides a means by which time stamps can be correlated to a unified wall clock, however RTCP information providing such information is not available at session establishment, precluding the ability to provide synchronized media concurrent with the start of a call/session.

H.323[2] is a protocol umbrella which includes H.223 Skew Indication as a message which can be relayed on an H245 Channel, but this message is forbidden for H323 IP terminals, i.e. it is not an available message/field for processing by an IP based video IVR.

U.S. Pat. No. 6,480,902[4] describes a system in which a synchronization forcer regulates the play time of audio signals and their corresponding video signals according to sequential marking of frames per every marking interval. However, this approach appears to be complex as it requires installation of intrusive functionality on the encode and decode paths.

U.S. Pat. No. 5,570,372[5] describes an approach in which an originating system provides delay information that is indicative of the dissimilarity of video and audio processing time at the originating system. The delay information is utilized at the receiving system to determine an adaptive compensation delay.

### REFERENCES

1. Schulzrinne et al; IETF RFC 3550; RTP: A Transport Protocol for Real Time Applications
2. Rosenberg et al; IETF RFC 3261; SIP: Session Initiation Protocol
3. ITU-T H.323; Series H: Audiovisual and Multimedia Systems, Packet Based Multimedia Communications Systems.
4. U.S. Pat. No. 6,480,902 (Institute for Information Industry)
5. U.S. Pat. No. 5,570,372 (Siemens Rohm Communications)

The invention is directed towards providing improved skew correction, particularly for communication between a server and multiple edge devices.

### SUMMARY OF THE INVENTION

According to the invention, there is provided a server for transmitting related audio and video streams to network edge devices, the server comprising a play-out skew correction component for adjusting relative time bases of the related audio and video streams to compensate for skew which will arise during transmission to an edge device or during processing of the streams by the edge device.

In one embodiment, the server is a mobile network media server.

In one embodiment, the server is a video interactive response server.

In another embodiment, the server further comprises an incoming stream skew correction component for performing time base adjustment for incoming related audio and video streams, whereby full duplex skew correction is achieved.

In one embodiment, the play-out skew correction component and the incoming stream skew correction component operate independently.

In one embodiment, the incoming stream skew correction function performs time base adjustment for related audio and video streams received from an edge device to save said streams to a media store.

In one embodiment, the incoming stream skew correction function performs said adjustment upon analysis of a received multimedia message from an edge device, to save the message to a message store.

In another embodiment, said adjustment is for correction of skew arising in the edge device or between the edge device and the server, and the server transmits the streams to a media store in a synchronized manner.

In one embodiment, the play-out skew correction component independently performs time base adjustment for communication with different edge devices according to characteristics of the edge devices.

In a further embodiment, the play-out skew correction component comprises a table correlating skew correction characteristics with edge devices, and means for performing look-ups to said table to determine skew correction parameters in real time.

In one embodiment, the incoming stream skew correction component independently performs time base adjustment for communication with different edge devices according to characteristics of the edge devices.

In one embodiment, the incoming stream skew correction component comprises a table correlating skew correction characteristics with edge devices, and means for performing look-ups to said table to determine skew correction parameters in real time.

In one embodiment, said table of the play-out skew correction component and said table of the incoming stream skew correction component are integrated.

In one embodiment, the play-out or the incoming stream skew correction components determine device identification information from session establishment signalling to enable device-specific time base adjustment to be applied concurrent with session establishment, and applies the same skew correction parameters to time base adjustment for the duration of a session.

In one embodiment, either or both of said components comprises means for extracting device information from VendorIdentificationInformation messages present on a H245 signalling channel for H323 connected calls.

In another embodiment, either or both of said components comprises means for extracting device information for SIP connected calls from a user-agent field in received INVITE messages.

The invention also provides a computer readable medium comprising software code for performing the time base adjustment operations of any server as defined above when executing on a digital processor.

In a further aspect, the invention provides a method of operation of an audio and video server, the method comprising transmitting related audio and video streams to a network edge device, the server adjusting relative time bases of the related audio and video streams to compensate for skew which will arise during transmission to the edge device or during processing of the streams by the edge device, and the edge device playing the audio and video streams in synchronized manner without performing any skew correction.

In one embodiment, the server performs time base adjustment independently for incoming related audio and video streams transmitted by an edge device, whereby full duplex skew correction is achieved.

In one embodiment, the time base adjustment is performed for related audio and video streams received from the edge device to save said streams to a media store.

In one embodiment, the server performs said adjustment upon analysis of a received multimedia message from the edge device, to save the message to a message store.

In one embodiment, said adjustment is for correction of skew arising in the edge device or between the edge device and the server, and the server transmits the streams to a media store in a synchronized manner.

In one embodiment, the server independently performs time base adjustment for transmission to different edge devices according to characteristics of the edge devices.

In one embodiment, the server performs look-ups to a table correlating skew correction characteristics with edge devices to determine skew correction parameters in real time.

In one embodiment, the server independently performs time base adjustment for communication with different transmitting edge devices according to characteristics of the edge devices.

In one embodiment, the server performs look-ups to a table correlating skew correction characteristics with edge devices, to determine skew correction parameters in real time for incoming audio and video streams.

In a further embodiment, the server determines device identification information from session establishment signalling to enable device-specific time base adjustment to be applied concurrent with session establishment, and applies the same skew correction parameters to time base adjustment for the duration of a session.

In one embodiment, the server extracts device information from VendorIdentificationInformation messages present on a H245 signalling channel for H323 connected calls.

In one embodiment, the server extracts device information for SIP connected calls from user-agent fields in received INVITE messages.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 is a diagram showing a network architecture for implementation of the invention;

FIG. 2 is a diagram showing skewed multi-media play-out; and

FIGS. 3 to 5 are diagrams showing skew correction.

### DESCRIPTION OF THE EMBODIMENTS

The invention provides skew correction between audio and video sources in a device independent manner such that the end result is accurate lip synchronization across all end user devices in a given network.

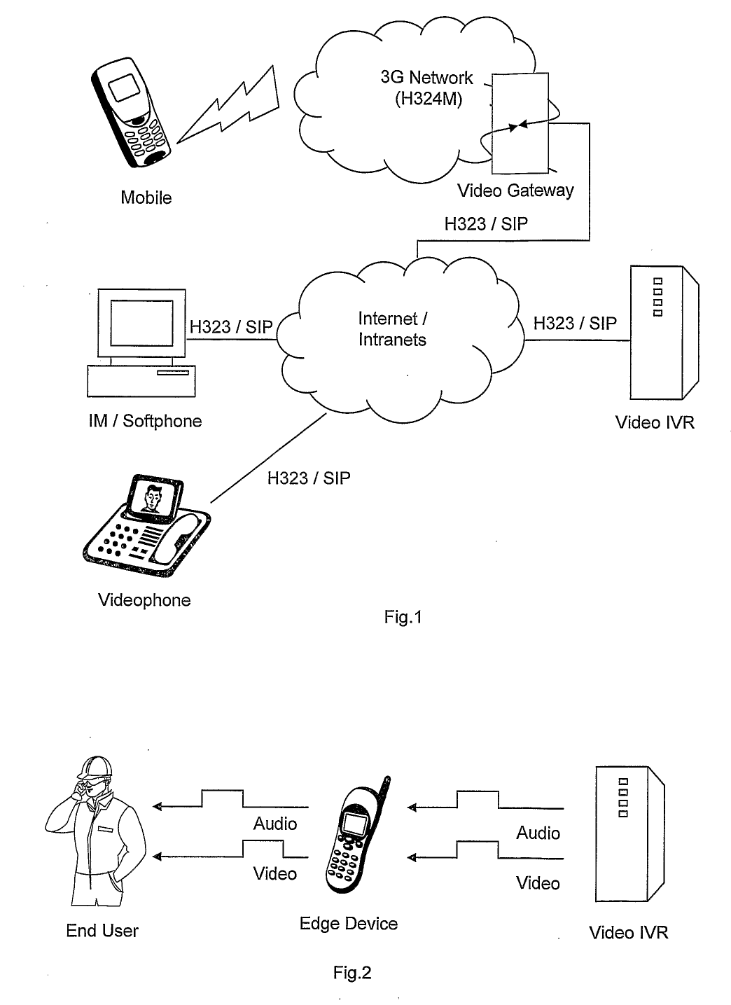

Successful user experience for video interactive services demands accurate lip synchronization; i.e., audio content must be synchronized with video content from the vantage point of the end user in order for the service to be acceptable. Enhanced services built upon video IVRs include various equipments which may adversely affect synchronization of audio with respect to video; while synchronization is maintained (or deemed accurate) at one demarcation point it is not necessarily acceptable (synchronized) to the end user. FIG. 1 depicts various components typically deployed in communication networks.

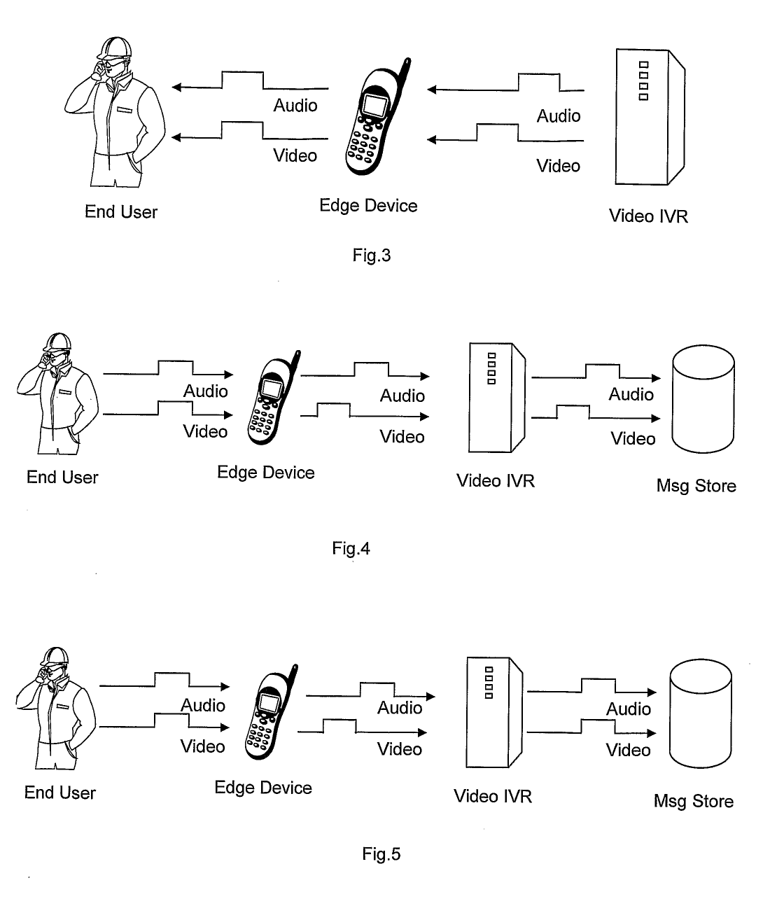

In order to correct the skew experienced by the end user, a ‘reverse skew’ is applied at the source of the data (the video IVR), resulting in synchronized data at the edge. FIG. 2 shows video lagging audio at the edge. However, by ‘sliding’ the time-bases of audio relative to video prior to delivery, in this case having video lead audio, the data as received by the end user is synchronized, as shown in FIG. 3. This is achieved without the edge (receiving device) needing to do anything to compensate for the skew. It merely receives synchronized audio and video streams.

Media interfaces towards the video IVR are full duplex; i.e. RTP streams for voice and video are sourced and received by the video IVR. Correcting the skew in the respective halves of the duplex is important, particularly dependent on the type of service being deployed on the video IVR. For storage (i.e. messaging) applications, correcting the skew of the received data is important prior to the actual storage of the data.

Referring to FIG. 4, in the prior art multimedia received at the edge device (from the end user) is in sync, but yet from the vantage point of the video IVR data received is skewed. The skewed data as received by the video IVR is also saved to the storage device with audio-video skew. However, in the invention, by applying the same technique as used for play-out, the skew can be corrected. The video IVR slides the time-base of audio relative to video before saving the multimedia data to the storage device. As a result, data saved is synchronized, as shown in FIG. 5.

Audio-video skew for the two halves of the media duplex may be altogether different, i.e., data received by the video IVR may have audio leading video, while for play-out, synchronized data sourced by the video IVR may be received by the end user with video leading audio. For this reason it is important for the video IVR to be able to correct the skew of the two halves of the duplex independently. Additionally, different edge devices deployed in a given network may exhibit different skew characteristics (as perceived by the end user), i.e. DeviceBrandX differs from DeviceBrandY as regarding skew. It is important for the video IVR to be able to correct the two halves of the duplex differently for different devices. This is possible by keeping the associated skew correction information in a (configuration) table within the video IVR, an example of which is given below (correction values being in units of milliseconds).

[DeviceBrandX]
PlaySkew=300
RecordSkew=700
[DeviceBrandY]
PlaySkew=0
RecordSkew=500

Device-specific correction is applied on a per call basis, i.e. independently for each call connected to the video IVR, commensurate with call connection (at the beginning of the call). Information identifying the specific device/brand connected to the video IVR is extracted from call signalling. For H323 connected calls, this is extracted from VendorIdentificationInformation messages present on the H245 signalling channel(s). For SIP connected calls, this is extracted from the user-Agent field in the received INVITE message.

The invention may be advantageously applied in any multimedia services, and is particularly advantageous for services having a video IVR component, such as a video messaging or video portal applications. For the mobile domain, it is particularly advantageous for UMTS networks. For the broadband domain, it may be applied to a wide range of multi-media/broadband networks in which video IVR services are provided. It will be appreciated that a major advantage is that the skew correction is achieved centrally by the server, with no intrusiveness in the path to the edge devices or in the edge devices.

The invention is not limited to the embodiments described but may be varied in construction and detail. For example, while in the embodiments described the look-up table is used for skew correction of incoming streams, it is possible that in other embodiments this is based on monitoring of the actual skew. This may be performed in real time as the streams arrive. Where this is the case, the server may incorporate a learning mechanism for updating the table if one exists.

1-29. (canceled)

30. A server for transmitting related audio and video streams to network edge devices, the server comprising:
a play-out skew correction component for adjusting relative time bases of the related audio and video streams to compensate for skew which will arise during transmission to an edge device or during processing of the streams by the edge device, and
an incoming stream skew correction component for performing time base adjustment for incoming related audio and video streams from an edge device, and for saving said streams to a media store, in which the skew correction is performed prior to the storage and synchronized data is stored.

31. The server as claimed in claim 30, wherein the server is a mobile network media server.

32. The server as claimed in claim 31, wherein the server is a video interactive response server.

33. The server as claimed in claim 30, wherein the play-out skew correction component and the incoming stream skew correction component operate independently.

34. The server as claimed in claim 30, wherein the incoming stream skew correction component is adapted to perform said time base adjustment upon analysis of a received multimedia message from an edge device, and to save the message to a message store.

35. The server as claimed in claim 30, wherein the play-out skew correction component is adapted to independently perform time base adjustment for communication with different edge devices according to characteristics of the edge devices.

36. The server as claimed in claim 35, wherein the play-out skew correction component comprises a table correlating skew correction characteristics with edge devices, and means for performing look-ups to said table to determine skew correction parameters in real time.

37. The server as claimed in claim 30, wherein the incoming stream skew correction component is adapted to independently perform time base adjustment for communication with different edge devices according to characteristics of the edge devices.

38. The server as claimed in claim 37, wherein the incoming stream skew correction component comprises a table correlating skew correction characteristics with edge devices, and means for performing look-ups to said table to determine skew correction parameters in real time.

39. The server as claimed in claim 38, wherein said table of the play-out skew correction component and said table of the incoming stream skew correction component are integrated.

40. The server as claimed in claim 30, wherein the play-out or the incoming stream skew correction components comprises means for determining device identification information from session establishment signalling to enable device-specific time base adjustment to be applied concurrent with session establishment, and for applying the same skew correction parameters to time base adjustment for the duration of a session.

41. The server as claimed in claim 40, wherein either or both of said components comprises means for extracting device information from VendorIdentificationInformation messages present on a H245 signalling channel for H323 connected calls.

42. The server as claimed in claim 40, wherein either or both of said components comprises means for extracting device information for SIP connected calls from user-agent fields in received INVITE messages.

43. A method of operation of an audio and video server, the method comprising:
a play-out skew correction component transmitting related audio and video streams to a network edge device, and adjusting relative time bases of the related audio and video streams to compensate for skew which will arise during transmission to the edge device or during processing of the streams by the edge device, and the edge device playing the audio and video streams in synchronized manner without performing any skew correction, and
an incoming stream skew correction component performing time base adjustment for incoming related audio and video streams from an edge device, and saving said streams to a media store, in which the skew correction is performed prior to the storage and synchronized data is stored.

44. The method as claimed in claim 43, wherein the play-out skew correction component and the incoming stream skew correction component operate independently.

45. The method as claimed in claim 43, wherein the incoming stream skew correction component performs said adjustment upon analysis of a received multimedia message from the edge device, and saves the message as synchronized audio and video streams to a message store.

46. The method as claimed in claim 43, wherein the play-out skew correction component independently performs time base adjustment for transmission to different edge devices according to characteristics of the edge devices.

47. The method as claimed in claim 46, wherein the play-out skew correction component performs look-ups to a table correlating skew correction characteristics with edge devices to determine skew correction parameters in real time.

48. The method as claimed in claim 43, wherein the incoming stream skew correction component independently performs time base adjustment for communication with different transmitting edge devices according to characteristics of the edge devices.

49. The method as claimed in claim 48, wherein the incoming stream skew correction component performs look-ups to a table correlating skew correction characteristics with edge devices, to determine skew correction parameters in real time for incoming audio and video streams.

50. The method as claimed in claim 43, wherein the server determines device identification information from session establishment signalling to enable device-specific time base adjustment to be applied concurrent with session establishment, and applies the same skew correction parameters to time base adjustment for the duration of a session.

51. The method as claimed in claim 50, wherein the server extracts device information from VendorIdentificationInformation messages present on a H245 signalling channel for H323 connected calls.

52. The method as claimed in claim 51, wherein the server extracts device information for SIP connected calls from user-agent fields in received INVITE messages.

53. The computer readable medium comprising software code for performing the time base adjustment operations of a method of claim 43 when executing on a digital processor.
